(19) United States
(12) Patent Application Publication
(10) Pub. No.: US 2025/0350105 A1
(43) Pub. Date: Nov. 13, 2025

(54) Drop Cable System

(71) Applicant: Steven Braga, Quincy, MA (US)

(72) Inventor: Steven Braga, Quincy, MA (US)

(21) Appl. No.: 18/661,420

(22) Filed: May 10, 2024

(51) Int. Cl. H02G 3/04; H02G 3/32

(52) U.S. Cl. CPC H02G 3/0468; H02G 3/32

(57) ABSTRACT

The present disclosure introduces a highly versatile and innovative drop cable system designed for efficient cable support, protection, and adaptability. This system comprises flexible cable tubing, multiple electric wires, support grips for strain relief, a mounting assembly, and modular ceiling utility panels. The system's flexible design ensures seamless cable routing even in confined spaces. Additionally, the use of modular ceiling utility panels provides for simplified cable connections and a straightforward method for adapting to changing setups. The method of use within laboratory or clean room settings further highlights the system's utility, allowing for clean, organized, and adaptable cable management.

### BACKGROUND OF THE INVENTION

The present disclosure relates generally to a drop cable system. More particularly, the present disclosure relates to a drop cable system that may advantageously be used with ceiling utility panels in a laboratory or clean room setting.

In numerous industries and settings, managing electrical wires, data cables, and other similar elements is an essential aspect of ensuring smooth operations and preventing potential damage. Challenges often arise in supporting and routing these cables, particularly in environments where space is limited, movement is required, or cables must be reconfigured frequently.

In laboratory settings in particular, the need for precise experimentation and data collection necessitates a clutter-free environment. However, conventional cable management solutions often result in tangled, unsightly cables that not only hinder movement and access but also pose contamination risks. The intricate and delicate instruments used in laboratories require cables to be precisely routed and securely supported to avoid interference with experiments or damage to expensive equipment.

Traditional cable management systems, which may lack flexibility, can impede the efficient functioning of laboratory setups and lead to potential inaccuracies in experimental results. Moreover, the frequent need to reconfigure experimental setups or relocate equipment further exacerbates the challenges, often requiring time-consuming rewiring, disrupting research activities.

Similarly, clean rooms demand an environment free from particulate contamination. Traditional cable management methods involving exposed cables can introduce foreign particles or create maintenance challenges. Moreover, the need for adaptability to accommodate changing clean room configurations, equipment placement, and instrumentation poses additional hurdles for cable management in such a setting.

In addition to the foregoing, there are still a number of problems with conventional cable management methods in both laboratory and clean room settings. There are also a potentially endless number of solutions to these problems. Therefore, what is needed is a drop cable system having all of the further described features and advantages.

### SUMMARY OF THE INVENTION

The subject matter of this application may involve, in some cases, interrelated products, alternative solutions to a particular problem, and/or a plurality of different uses of a single system or article.

In one aspect, a drop cable system is disclosed. In this aspect, the system includes a cable tubing with an open interior, wherein a plurality of electric wires are housed within the cable tubing. The system also includes a mounting assembly configured to connect the cable tubing to a ceiling structure.

In another aspect, a method of using the drop cable system in a laboratory or a clean room is disclosed. In this aspect, the method involves a number of steps. The steps include installing the drop cable system within either the laboratory or the clean room, routing a plurality of electric cables using the drop cable system, and ensuring strain relief using a mounting assembly. The method also involves connecting the plurality of electric cables to a modular ceiling utility panel.

### BRIEF DESCRIPTION OF DRAWINGS

FIG. 1 provides a perspective view of one embodiment of a cable tubing according to the present disclosure.

FIG. 2 provides a perspective view of one embodiment of a drop cable according to the present disclosure.

FIG. 3 provides perspective view of one embodiment of a drop cable system according to the present disclosure.

FIG. 4 provides a perspective view of another embodiment of a drop cable system according to the present disclosure.

FIG. 5 provides a perspective view of a plurality of drop cable systems according to the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and/or the sequence of steps for constructing and operating the invention in connection with the illustrated embodiments.

Generally, the present disclosure concerns a drop cable system. Specifically, the drop cable system may be advantageously used with a ceiling utility panel (“CUP”) to provide for streamlined management and distribution of electric utilities within a building or workspace. CUPs may be installed on or near a ceiling and may have multiple ports or connectors that may accommodate different types of utility connections, including electrical outlets, data ports (e.g., Ethernet, HDMI, etc.), audiovisual connections, and the like. In some embodiments, the drop cable system may include a drop cable connected to a modular CUP. The internal wiring and the features of the modular CUP may be customized to suit the specific needs of a particular area.

The drop cable may be designed to support and protect suspended electric cables or cords, thereby reducing the risk of damage due to breakage or stress. In one embodiment, the drop cable may be specifically engineered for a light-duty indoor application and comprise various lengths and widths to suit a diverse range of requirements.

In some embodiments, the drop cable material may feature a leak-proof, flexible tubing designed to accommodate Cat 6, Cat 6A, or fiber optic cables, which may ensure the protection of electrical wires during routing applications. The particular material used to manufacture the drop cable tubing may make the cable itself well-suited for use in extremely tight spaces, offering the convenience of fast installation and maximum flexibility. The drop cable tubing may also have optimal tensile strength, enhancing its durability and reliability. Additionally, the drop cable tubing may comprise a smooth interior wall, which may safeguard wiring from potential damage. Accordingly, the presently disclosed drop cable may provide an ideal solution for areas where movement, vibrations, or flexing can pose challenges.

While the preferred embodiment of the drop cable system may be most advantageously used to provide flexible cable management in a laboratory or clean room setting, the drop cable may also be used across a versatile range of applications. For example, the drop cable may comprise oil resistant material and may be used in an environment where resistance to oil is required, ensuring optimal performance in such conditions.

The drop cable may also comprise corrosion protection, making it useful in locations where water corrosion or exposure to ultraviolet (“UV”) light is a concern. The drop cable tubing may be manufactured to allow internal electric cables to operate within a temperature range of −4° F. to 140° F. (i.e., −20° C. to 60° C.), ensuring versatility in various environmental conditions, such as, for example, in marine environments where harsh conditions are often prevalent.

The drop cable may also play a critical role in preserving the signal integrity of delicate fiber optic cables. The drop cable may also be used in installing instrumentation or control cables, ensuring secure and reliable connections. In suspended applications, such as where the drop cable may be attached to a ceiling, the drop cable system may utilize a wire harness to prevent damage and ensure the longevity of the drop cable tubing. The drop cable may also comply with various industry and safety standards, including being rated for watertight applications and suitable for environments where protection against moisture and dust are essential.

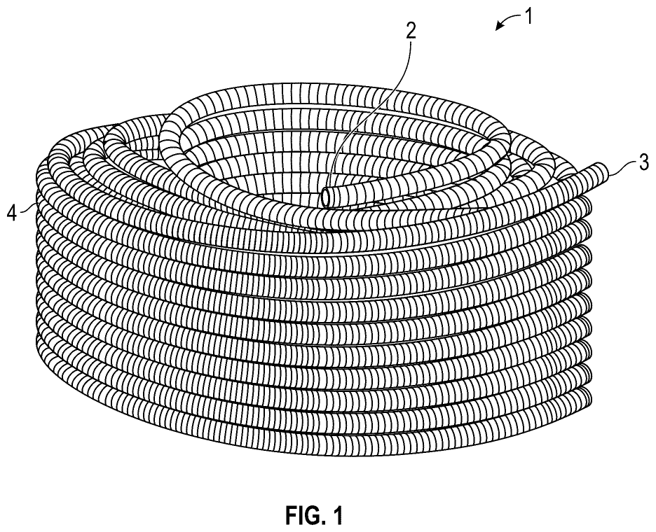

Referring now to FIG. 1, a perspective view of one embodiment of a drop cable tubing 1 is provided. The tubing 1 possesses two primary ends: a proximal end 2 and a distal end 3. The tubing 1 is designed to enclose and protect electric wires or cables. It defines an open interior that extends from the proximal end 2 to the distal end 3. This open interior provides a conduit for the routing of different electric wires or cables, serving as a critical component of the drop cable system.

The tubing 1 is constructed from a flexible material 4. This material is chosen for its properties, including resistance to oil, water, or UV light. Such characteristics make the tubing 1 suitable for safeguarding electric wires housed within the tubing 1 during various applications.

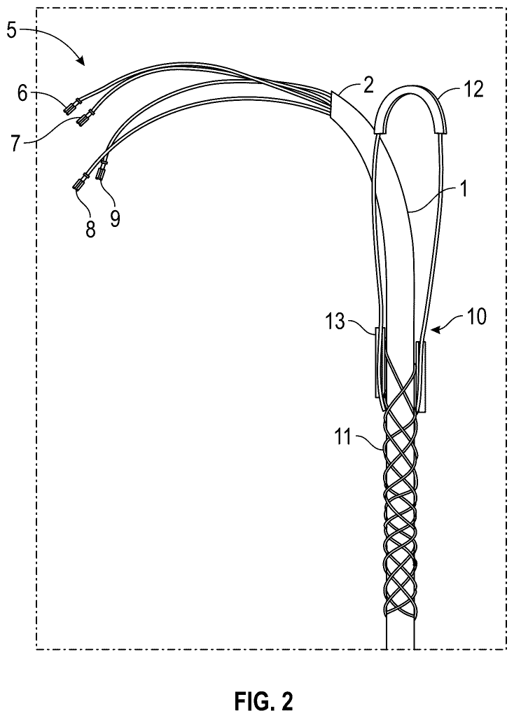

FIG. 2 provides a detailed perspective view of an embodiment of the drop cable 1. The electric wires 5 within the drop cable 1 are essential for the secure transmission of various types of signals and power.

The drop cable 1 comprises a cable tubing with several electric wires 5 emerging from its proximal end 2 and extending longitudinally within the tubing. In this specific embodiment, four wires 5 are accommodated within the cable 1, each serving a distinct function. For example, the power line 6 is designed for the transmission of electrical power. The data line 7 is dedicated to carrying data signals. The network line 8 facilitates the transmission of network signals, and the telephone line 9 is designated for telecommunication purposes.

A notable feature of the drop cable 1 is the inclusion of a mounting assembly 10. In this embodiment, the mounting assembly 10 contains a wire cord 11 that is securely wound around the exterior of the drop cable 1, near its proximal end 2. The wire cord 11 is wrapped around the tubing and affixed to a reinforced hanger eye 12, ensuring stability and support for the drop cable 1 during installation and usage. A wire harness 13 is employed to secure the wire cord 11 in place on the tubing, further enhancing the structural integrity of the drop cable 1.

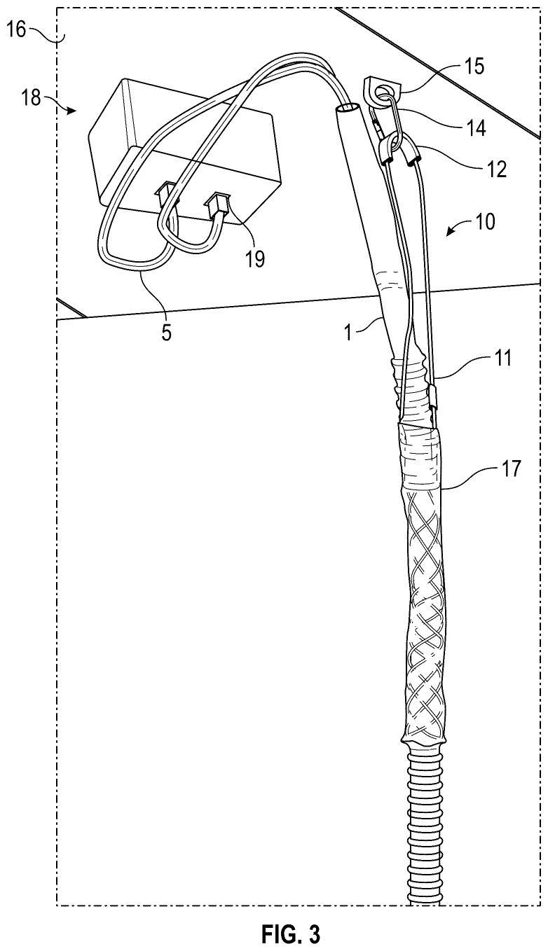

FIG. 3 provides a comprehensive perspective view of one embodiment of the drop cable system incorporating the drop cable 1 and the mounting assembly 10. In this embodiment, the mounting assembly 10 includes additional elements that are critical to the functionality of the system.

For example, the carabiner clip 14 serves as a crucial link with the assembly, connecting the reinforced hanger eye 12 of the drop cable 1 to a hook 15. The hook 15 is securely anchored to a ceiling 16, providing a stable point of attachment for the system.

An important feature illustrated in this embodiment is the provision of strain relief, which plays a crucial role in maintaining the structural integrity of the suspended drop cable 1. For example, connecting the mounting assembly 10 to the ceiling 16 ensures strain relief by equalizing and distributing loads evenly through the suspended cable 1. This approach minimizes stress and potential damage to the drop cable 1, thus enhancing its overall reliability and lifespan.

Similarly, the wire cord 11 is wound around the exterior of the tubing and plays a critical role in supporting the dead weight of the drop cable 1. In this embodiment, a protective sleeve 17 envelops the cord 11, serving a dual purpose. The first purpose relates to protection, as the sleeve 17 safeguards the wire cord 11 from external elements and potential damage, enhancing the longevity of the support system. Additionally, the sleeve 17 contributes to the visual appeal of the suspended drop cable, improving its overall aesthetic appearance.

Within the drop cable 1, two of the electric wires 5 are specifically designated as data wires, and they play a crucial role in data transmission. Particularly, this embodiment of the drop cable system incorporates a CUP 18 mounted to the ceiling 16 in proximity to the hook 15.

In this embodiment, the CUP 18 is a modular device designed to facilitate the convenient connection and disconnection of the electric wires 5, offering several advantages. First, the CUP 18 simplifies the process of connecting and disconnecting the wires 5, providing ease of use for maintenance or adjustments. Similarly, the wires 5 are plugged into ports 19 on the CUP 18, creating a reliable and efficient interface for signal transmission.

It is important to note that, were it not for the presence of the mounting assembly 10, which offers strain relief and even loading distribution as described previously, the ports 19 on the CUP 18 would bear the entire burden of supporting the dead weight of the wires 5 and the cable 1. Accordingly, the mounting assembly 10 play a critical role in providing strain relief, thereby preventing the wires 5 from inadvertently disconnecting from the ports 19 of the CUP 18, ensuring the stability and reliability of the drop cable system.

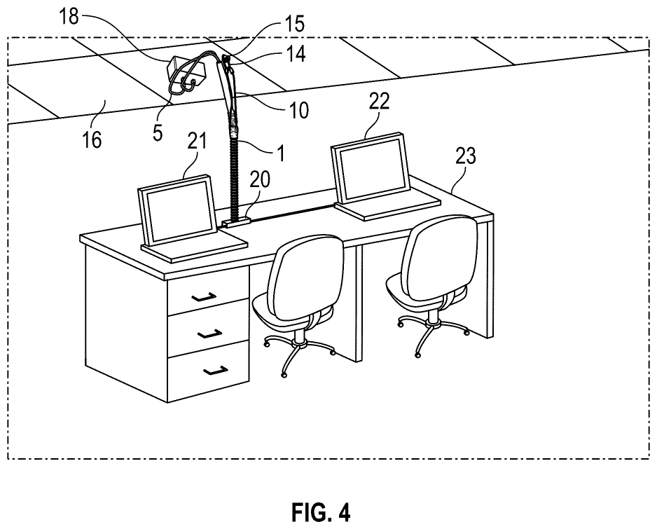

FIG. 4 illustrates another embodiment of the drop cable system, offering expanded functionality by introducing an electronic interface 20 and connections to electronic devices. Similar to the previous embodiment, the drop cable 1 remains central to the system with its proximal end connected to the CUP 18 via electric wires 5 and its distal end linked to the electronic interface 20.

As used herein, the term “electronic interface” generally refers to a component or device that serves as an intermediary between electronic systems, enabling them to communicate, exchange data, or interface with each other. An electronic interface can take various forms and may encompass a range of functionalities, such as signal conversion, data transmission, or protocol conversion. An electronic interface may include ports, connectors, or circuitry that facilitate the exchange of data, signals, or power between the drop cable system and the electronic devices.

Similarly, as used herein, the term “electronic device” refers to a wide range of devices, equipment, or systems that utilize electronic components and technology to perform various functions or tasks. These devices may rely on electrical circuits, semiconductor components, and/or digital processing to receive, process, store, or transmit information, signals, or data. Some non-limiting examples of electronic devices in this context are computers, measurement instruments, analytical equipment, data acquisition devices, and the like.

In this embodiment, and still referring to FIG. 4, the electronic interface 20 serves as the critical component bridging the drop cable 1 and electronic devices. For example, the electric wires 5 within the drop cable 1 are connected to the CUP 18, and the electronic interface 20 establishes connections between the wires 5 and two electronic device. Specifically, the two electronic devices are computers 21 and 22. It should be expressly understood that while computers are illustrated in this embodiment, the system can accommodate various electronic devices typically required in laboratory or clean room settings. In at least one alternative embodiment, the electric wires 5 may be connected directly to the electronic devices.

The electronic interface 20 and the connected computers 21 and 22 are positioned on a versatile workbench 23. As a result of the flexible nature of the drop cable system, this workbench 23 may be relocated within the laboratory or clean room as needed for different experiments or tasks. For example, in this embodiment, the mobility of the workbench 23 is achieved by disconnecting the drop cable 1 and/or electric wires 5 from the CUP 18. The mounting assembly 10, connected to the ceiling 16 via the carabiner clip 14, may then be unhooked, facilitating relocation of the workbench 23.

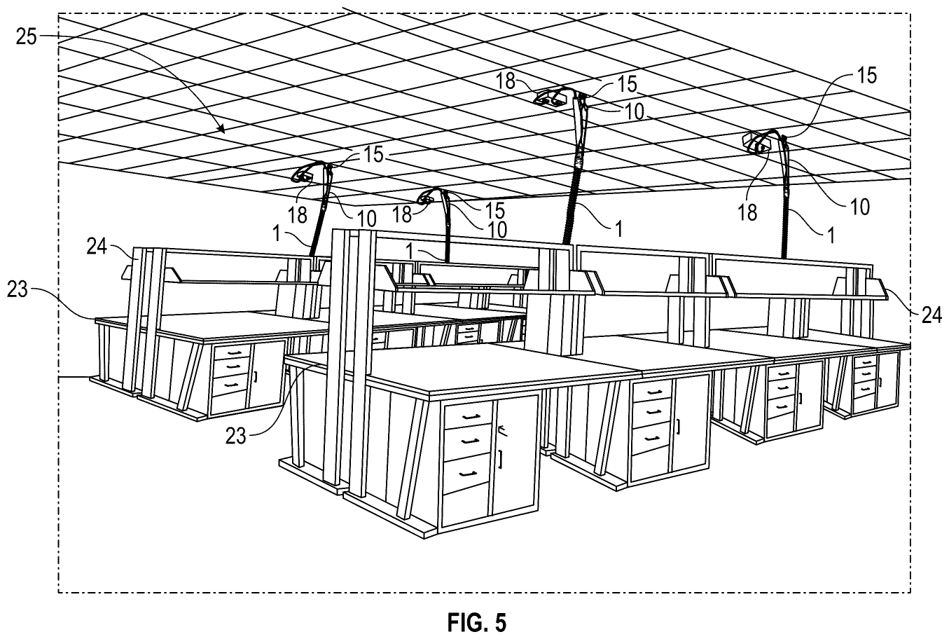

FIG. 5 illustrates a dynamic application of the drop cable system with a laboratory 25, where the system is employed to enhance flexibility and efficiency in handling electronic connections. As shown, within this laboratory 25, several drop cable systems are deployed, each comprising a drop cable 1 connected to a CUP 18 and secured by a mounting assembly 10 attached to a ceiling hook 15.

In this embodiment, the drop cables 1 are routed through rack assemblies 24 that are strategically connected to workbenches 23 within the laboratory. This arrangement ensures organized cable management and prevents potential tangling or similar disarray. At the distal end of each drop cable 1, a single consolidated electrical connection or multiple electrical connections are made accessible, either directly on the workbenches 23 or through the rack assemblies 24. This accessibility streamlines the connection of electronic devices and facilitates their placement within the laboratory 25.

A critical advantage illustrated by this embodiment lies in its ability to enhance the mobility and convenience of workstations within the laboratory 25. The system achieves this by allowing workstations to be moved around the laboratory 25 without the need for cumbersome and complicated rewiring. In this embodiment, the relocation process begins by merely unplugging or disconnecting one or more drop cables 1 from their respective CUPs 18 and unhooking the mounting assembly 10 from the ceiling. In order to relocate a workbench 23, the new location must have a CUP 18 or an equivalent electrical connection within reach of the drop cable 1, ensuring effective transition of operations.

In short, the various embodiments described herein highlight the drop cable system's adaptability to various requirements, making it ideal for a wide range of experiments, tests, or research activities. Furthermore, while several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A drop cable system, comprising:
a cable tubing with an open interior;
a plurality of electric wires housed within the cable tubing; and
a mounting assembly configured to connect the cable tubing to a ceiling structure.

2. The drop cable system of claim 1 wherein the cable tubing comprises a flexible material, wherein the flexible material is resistant to at least one of oil, water, or ultraviolet light.

3. The drop cable system of claim 1 wherein the plurality of electric wires comprise at least one of a power line, a data line, a network line, or a telephone line.

4. The drop cable system of claim 1 wherein the mounting assembly comprises a wire cord wrapped around an exterior of the cable tubing.

5. The drop cable system of claim 4 further comprising a wire harness for securing the wire cord to the cable tubing.

6. The drop cable system of claim 4 further comprising a reinforced hanger eye attached to the wire cord.

7. The drop cable system of claim 1 further comprising a carabiner clip, the carabiner clip connecting the mounting assembly to the ceiling structure.

8. The drop cable system of claim 1 wherein the ceiling structure comprises a hook.

9. The drop cable system of claim 1 further comprising a protective sleeve covering the cable tubing.

10. The drop cable system of claim 1 further comprising a modular ceiling utility panel.

11. The drop cable system of claim 10 wherein the plurality of electric wires are connected to the modular ceiling utility panel.

12. The drop cable system of claim 10 wherein the modular ceiling utility panel comprises a plurality of ports.

13. The drop cable system of claim 12 wherein the plurality of electric wires protrude from a proximal end of the cable tubing and connect to the plurality of ports on the modular ceiling utility panel.

14. The drop cable system of claim 1 further comprising a modular ceiling utility panel and an electronic interface, wherein the plurality of electric wires are connected to the modular ceiling utility panel and the electronic interface.

15. A method of using a drop cable system in a laboratory or a clean room, comprising a plurality of steps of:
installing the drop cable system within at least one of the laboratory or the clean room;
routing a plurality of electric cables using the drop cable system;
ensuring strain relief using a mounting assembly; and
connecting the plurality of electric cables to a modular ceiling utility panel.

16. The method of using the drop cable system of claim 15 further comprising connecting the plurality of electric cables to an electronic interface.

17. The method of using the drop cable system of claim 16 wherein the electronic interface is positioned on a workbench.

18. The method of using the drop cable system of claim 15 further comprising disconnecting the plurality of electric cables from the modular ceiling utility panel.

19. The method of using the drop cable system of claim 18 further comprising disconnecting the plurality of electric cables from an electronic interface positioned on a workbench.

20. The method of using the drop cable system of claim 19 further comprising reconnecting the plurality of electric cables to the modular ceiling utility panel and the electronic interface after moving the workbench to a different location in at least one of the laboratory or the clean room.
